(19) United States
(12) Patent Application Publication
(10) Pub. No.: US 2004/0198384 A1
(43) Pub. Date: Oct. 7, 2004

(54) Mobile communications device integrating positioning function and method for displaying positioning information in real time thereof

(75) Inventor: Chun I Sun, Taipei (TW)

Correspondence Address: BROWDY AND NEIMARK, P.L.L.C., 624 NINTH STREET, NW, SUITE 300, WASHINGTON, DC, 20001-5303, US

(73) Assignee: Kinpo Electronics, Inc., Taipei (TW)

(21) Appl. No.: 10/316,842

(22) Filed: Dec. 12, 2002

(51) Int. Cl. H04B 1/10; H04B 1/16; H04Q 7/20; H04M 1/00; H04B 1/38

(52) U.S. Cl. 455/456.1; 455/213; 455/556.1

(57) ABSTRACT

A mobile communications device integrating positioning function and a method for displaying positioning information in real time thereof are proposed, wherein a mobile phone and a receiver for receiving satellite signals are connected and assembled together. The receiver is connected to a connection interface of the mobile phone. The receiver has a GPS module and a microprocessor therein. The receiver receives digital data emitted by satellites through the GPS module. The microprocessor converts the received digital data into data of positioning parameters, which are transmitted to the mobile phone. A user thus can directly know coordinates and information of his position in real time from the screen of the mobile phone, hence accomplishing satellite positioning function with a lower cost.

### FIELD OF THE INVENTION

The present invention relates to a mobile communications device integrating positioning function and a method for displaying positioning information in real time thereof and, more particularly, to a device and a method integrating a mobile phone with a global positioning system (GPS) receiver to let the mobile phone be capable of directly displaying coordinates and information of the present position.

### BACKGROUND OF THE INVENTION

Along with keener and keener competition of the mobile communications market, the techniques of mobile phones develop vigorously. The adopted mobile communications systems can be divided into global system mobile (GSM), personal handyphone System(PHS), personal access communications system (PACS), digital European cordless telephone (DECT), cordless telephone, second generation (CT-2) and so on. Because a mobile communications system is mainly a dense communications network built with many base stations, when a mobile phone is located within the communication range of the base stations, it can make or receive a call normally. Moreover, the position where the mobile phone is can be roughly known.

If a user wants to know exactly where he is, it is necessary to use a satellite positioning device capable of receiving signals emitted by the global positioning system (GPS). This satellite positioning device basically comprises a satellite signal receiver, inbuilt map data and a display screen. Through the above satellite positioning device, real-time and continually and automatically renewed digital data of the located position can be provided for the user. These digital data having position information can be extensively applied to positioning navigation, accident rescue, transportation fleet supervision or guard against burglary for car.

However, in mountain accidents nowadays, the suffering people usually seek for help by dialing mobile phones. If others cannot rescue the suffering people immediately, it is hard for them to only using the mobile phones for self-relief.

Although the mobile phones can be used to roughly locate the position, they cannot exactly locate the coordinates and direction as the GPS system in practice. Moreover, the cost of the above satellite positioning device is higher. If a mobile phone and a GPS receiver can be integrated together, the screen cost of the satellite positioning device can be effectively saved.

Accordingly, the present invention aims to resolve the problems in the prior art.

### SUMMARY OF THE INVENTION

The primary object of the present invention is to provide a mobile communications device integrating positioning function and a method for displaying positioning information in real time thereof, wherein a GPS communications module is connected externally to a mobile phone. A lower cost and a higher portability can thus be accomplished than a complete GPS system because a screen of the mobile phone can replace the display device of the GPS system.

Another object of the present invention is to provide a mobile communications device integrating positioning function and a method for displaying positioning information in real time thereof, whereby when the communications of the mobile phone is normal, an electronic map of the location of the mobile phone can be obtained and displayed on the screen of the mobile phone through cooperation of the mobile communications system provider. Once a user goes astray, he can receive data of digital parameters corresponding to the electronic map via the GPS communications module to find the best route to the destination.

To achieve the above objects, the present invention provides a mobile communications device integrating positioning function, which comprises a mobile phone and a receiver. The mobile phone has a connection interface. The receiver is connected to the connection interface. The receiver comprises a GPS module for receiving satellite signals, and is used to transmit received digital data to the mobile phone via the connection interface.

To achieve the above objects, the present invention also provides a method for displaying positioning information in real time, wherein a mobile phone and a receiver for receiving satellite signals are connected and assembled together. The method comprises the steps of:

(a) receiving digital data using the receiver;

(b) converting the digital data into data of positioning parameters; and

(c) transmitting the data of positioning parameters to the mobile phone.

The various objects and advantages of the present invention will be more readily understood from the following detailed description when read in conjunction with the appended drawing, in which:

### BRIEF DESCRIPTION OF THE DRAWINGS

FIG. 1 is a circuit block diagram showing the connection between a mobile phone and a GPS receiver of the present invention; and

FIG. 2 is a flowchart of the connection operation of a mobile phone and a GPS receiver of the present invention.

### DETAILED DESCRIPTION OF THE PREFERRED EMBODIMENTS

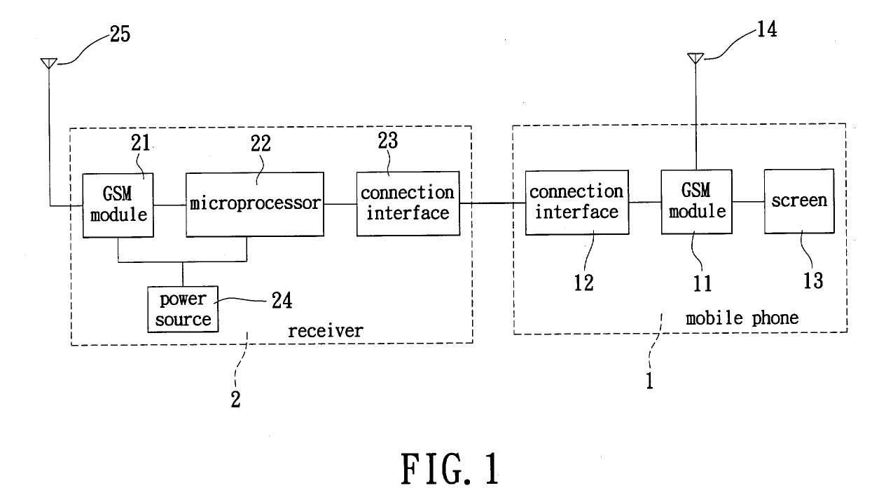

As shown in FIG. 1, the present invention provides a mobile communications device integrating positioning function, which mainly comprises a mobile phone 1 and a receiver 2 for receiving satellite signals.

This embodiment of the present invention is exemplified with the mobile phone 1 using the GSM mobile communications system. However, the present invention is not limited to the GSM mobile communications system, but can also apply to other kinds of mobile communications systems (e.g., PHS, PACS, DECT and CT-2). The mobile phone 1 comprises a GSM module 11, a connection interface 12 connected to the receiver 2 and a screen 13 for displaying text or picture messages. The GSM module 11 achieves interconnection with base stations of the mobile communications system provider.

The receiver 2 comprises a GPS module 21, a microprocessor 22, a connection interface 23 and a power source 24. The GPS module 21 is used to receive digital data emitted by satellites. The microprocessor 22 converts the digital data into data of positioning parameters received by the mobile phone 1. That is, positioning coordinates and information represented by the digital data are converted by the microprocessor 22 into the data of positioning parameters, which can be discriminated by the mobile phone 1. Contents of the above data of positioning parameters include the longitude, the latitude, the altitude, the moving speed, the direction and so on of the location of the receiver 2. Through connection of the connection interface 23 of the receiver 2 and the connection interface 12 of the mobile phone 1, the data of positioning parameters can be transmitted to the mobile phone 1 for display using AT command sets or GSM command formats.

Additionally, the receiver 2 is connected externally to the mobile phone 1. The power source 24 for providing electricity for the GPS module 21 and the microprocessor 22 is disposed in the receiver 2. If the connection interface 12 of the mobile phone 1 can directly provide power output, the power source 24 in the receiver 2 can be saved.

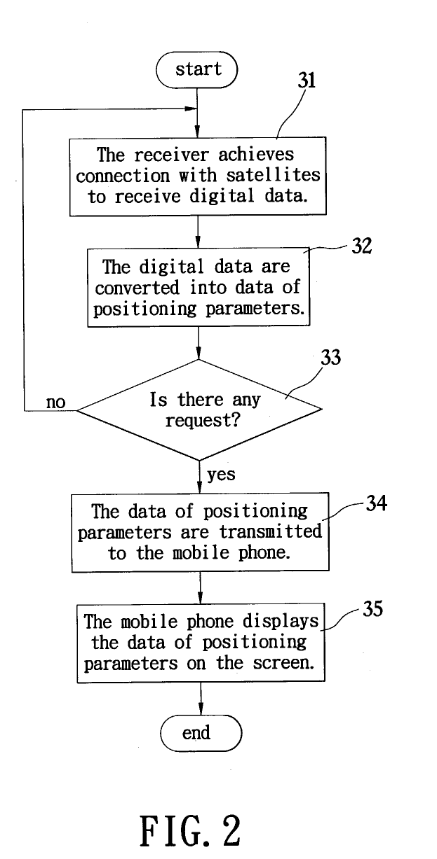

As shown in FIG. 2, the present invention also provides a method for displaying positioning information in real time. The method comprises the following steps.

Step 31: The receiver 2 achieves connection with satellites to receive digital data;

Step 32: The microprocessor 22 converts the digital data into data of positioning parameters;

Step 33: The microprocessor 22 determines whether there is any request for displaying the data of positioning parameters. If the answer is positive, Step 34 is jumped to; otherwise, Step 31 is jumped back to;

Step 34: The microprocessor 22 transmits the data of positioning parameters to the mobile phone 1 via the connection interfaces 23 and 12;

Step 35: The mobile phone 1 displays the data of positioning parameters on the screen 13. The data of positioning parameters can be integrated into the telephone directory, the notebook or other function menus convenient for user's reading of the mobile phone 1.

The above Step 33 can be directly omitted. Instead, the receiver 2 converts received digital data into data of positioning parameters and then directly transmits them to the screen 13 of the mobile phone 1 for real-time display. Besides, after the mobile phone 1 obtains the data of positioning parameters, it can send out a signal to request a corresponding simple electronic map from the mobile communications system provider via the communications network and then display the map on the screen 13 thereof. When a user goes astray, he can find out the best route to the destination using the previously obtained positioning parameter matched with the electronic map.

In the present invention, the receiver 2 is connected externally to the mobile phone 1, software control and the communications network of the mobile phone 1 are matched, and electronic map transmission service provided by the mobile communication system provider are exploited. Thereby, the obtained data of positioning parameters and electronic map can be displayed on the screen 13 of the mobile phone 1. The mobile phone 1 and the receiver 2 are connected and assembled together to form a GPS satellite positioning device having positioning function.

To sum up, the mobile communications device integrating positioning function and the method for displaying positioning information in real time thereof of the present invention have the following characteristics.

(1) After the mobile phone is connected externally to the GPS receiver, various kinds of accurate position coordinates and information like the longitude, the altitude, the latitude, the moving speed and the direction of the current position of the receiver can be obtained in real time. Moreover, the volume of the whole device can be greatly shrunk for convenient portability, and the cost is lower.

(2) Because the mobile phone is connected externally to the GPS receiver, an inbuilt map storage is not required because the electronic map service can be obtained via the communications network using the communications function of the mobile phone itself.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A mobile communications device integrating positioning function, comprising:
a mobile phone having a connection interface; and
a receiver connected to said connection interface, said receiver comprising a GPS module for receiving satellite signals, said receiver being used to transmit received digital data to said mobile phone via said connection interface.

2. The mobile communications device integrating positioning function as claimed in claim 1, wherein said mobile phone uses a mobile communications system like GSM, PHS, PACS, DECT or CT-2.

3. The mobile communications device integrating positioning function as claimed in claim 1, wherein said receiver further comprises a power source.

4. The mobile communications device integrating positioning function as claimed in claim 1, wherein said receiver further comprises a microprocessor, and said microprocessor is used to convert said digital data into data of positioning parameters before transmitting to said mobile phone via said connection interface.

5. The mobile communications device integrating positioning function as claimed in claim 4, wherein said data of positioning parameters are transmitted using a command format of AT command sets.

6. The mobile communications device integrating positioning function as claimed in claim 4, wherein said data of positioning parameters are displayed on a screen of said mobile phone.

7. The mobile communications device integrating positioning function as claimed in claim 4, wherein said data of positioning parameters include information like longitude, latitude, altitude, moving speed and direction.

8. A method for displaying positioning information in real time, wherein a mobile phone and a receiver for receiving satellite signals are connected and assemble together, said method comprising the steps of:
(a) receiving digital data using said receiver;
(b) converting said digital data into data of positioning parameters; and
(c) transmitting said data of positioning parameters to said mobile phone.

9. The method for displaying positioning information in real time as claimed in claim 8, wherein said mobile phone uses a mobile communications system like GSM, PHS, PACS, DECT or CT-2.

10. The method for displaying positioning information in real time as claimed in claim 8, wherein said receiver is a GPS receiver.

11. The method for displaying positioning information in real time as claimed in claim 8, wherein said receiver further comprises a microprocessor, and said microprocessor is used to convert said digital data into data of positioning parameters.

12. The method for displaying positioning information in real time as claimed in claim 8, wherein said data of positioning parameters in said Step (c) are transmitted using a command format of AT command sets.

13. The method for displaying positioning information in real time as claimed in claim 8, wherein said data of positioning parameters in said Step (c) are displayed on a screen of said mobile phone.

14. The method for displaying positioning information in real time as claimed in claim 8, wherein said data of positioning parameters in said Step (c) include information like longitude, latitude, altitude, moving speed and direction.
